(19) United States
(12) Patent Application Publication
(10) Pub. No.: US 2024/0427833 A1
(43) Pub. Date: Dec. 26, 2024

(54) METHOD AND SYSTEM FOR PROVIDING CONTENTS

(71) Applicant: NAVER WEBTOON Ltd., Seongnam-si (KR)

(72) Inventors: Hye Kyung KIM, Seongnam-si (KR); Ka In CHOI, Seongnam-si (KR); Ji Won KIM, Seongnam-si (KR); Sung Uk CHUNG, Seongnam-si (KR); Seung Wook OH, Seongnam-si (KR); Seung Taek LIM, Seongnam-si (KR); Ji Hyun KIM, Seongnam-si (KR); Jae Seon JEONG, Seongnam-si (KR)

(73) Assignee: NAVER WEBTOON Ltd., Seongnam-si (KR)

(21) Appl. No.: 18/822,754

(22) Filed: Sep. 3, 2024

Related U.S. Application Data
(63) Continuation of application No. PCT/KR2023/002918, filed on Mar. 3, 2023.

(30) Foreign Application Priority Data
Mar. 3, 2022 (KR) 10-2022-0027431

(51) Int. Cl. G06F 16/958; G06Q 30/02

(52) U.S. Cl. CPC G06F 16/958; G06Q 30/02

(57) ABSTRACT

Methods and systems for providing contents may be provided. A method of providing contents may include specifying contents to be serialized on a specific day of a week, among a plurality of contents each serialized with reference to a day of the week, calculating a popularity ranking for each of the specified contents, selecting, using the popularity ranking, a ranking-boosting content satisfying a ranking condition among the specified contents, and providing, on a user terminal, items corresponding to each of the specified contents, wherein the providing includes displaying ranking-boosting information related to ranking-boosting on an item corresponding to the ranking-boosting content, among the items corresponding to each of the specified contents. Accordingly, information on contents that is serialized with respect to a specific day of the week may be more effectively provided.

### CROSS-REFERENCE TO RELATED APPLICATIONS

This U.S. non-provisional application is a continuation of and claims the benefit of priority under 35 U.S.C. § 365(c) to International Application PCT/KR2023/002918, which has an international filing date of Mar. 3, 2023 and claims priority to Korean Patent Application No. 10-2022-0027431, filed Mar. 3, 2022, the entire contents of each of which are incorporated herein by reference in their entirety.

### BACKGROUND

### 1. Field

Example embodiments of the present inventive concepts relates to methods and systems for providing contents, in particular, to methods and systems for providing contents that is capable of more effectively providing information on contents that is serialized with respect to a specific day of the week.

### 2. Description of the Related Art

As technology advances, the use of a digital device increases. In particular, a user terminal (e.g., smartphone, tablet PC, etc.) is equipped with various functions including communication functions such as a phone call or text messaging, as well as surfing the web, listening to music, and watching videos using the Internet.

With the popularization of various user terminals, consumption of contents provided through user terminal such as PC or mobile devices is rapidly increasing, unlike the conventional content consumption media. For example, one form of such contents is comics.

As the consumption of these comics continues to increase, various service providers (or comics-related service providers) are developing various services to secure users (or consumers, subscribers) who can use the services steadily.

Meanwhile, in order to ensure continuous consumption of contents such as comics, content providing services are serializing contents in various ways. For example, by serializing a specific content on a specific day of the week, users are encouraged to visit every specific day of the week to use the users' favorite content.

### SUMMARY

The present inventive concepts relate to methods and systems for providing contents that is capable of more effectively providing users with various information on contents.

More specifically, the present inventive concepts relate to methods and systems for providing contents that provides a user environment that enables a user to identify at a glance information on the contents that is serialized for a specific day of the week.

Further, the present inventive concepts relate to methods and systems for providing contents that provides a user environment that enables a user to intuitively identify information on popular contents.

According to an example embodiment, a method of providing contents may include specifying contents to be serialized on a specific day of a week among a plurality of contents each serialized with reference to a day of the week, calculating a popularity ranking for each of the specified contents, selecting, using the popularity ranking, a ranking-boosting content satisfying a ranking condition among the specified contents, and providing, on a user terminal, items corresponding to each of the specified contents, wherein the providing includes displaying ranking-boosting information related to ranking-boosting on an item corresponding to the ranking-boosting content, among the items corresponding to each of the specified contents.

According to an example embodiment, a system for providing contents may include a database configured to store a plurality of contents, and processing circuitry configured to specify contents to be serialized on a specific day of a week among the plurality of contents, calculate a popularity ranking for each of the specified contents to be serialized on the specific day of the week, select, using the popularity ranking, a ranking-boosting content satisfying a ranking condition among the specified contents, and provide, on a user terminal, items each corresponding to the specified contents, wherein the processing circuitry is configured to provide the items by displaying ranking-boosting information related to ranking-boosting on an item corresponding to the ranking-boosting content, among the items corresponding to each of the specified contents.

According to an example embodiment, there is provided a non-transitory computer readable medium storing a program that when executed by one or more processors on an electronic device, causes the electronic device to perform a method of providing contents. The method may include specifying contents to be serialized on a specific day of a week among a plurality of contents each serialized with reference to a day of the week, calculating a popularity ranking for each of the specified contents, selecting, using the popularity ranking, a ranking-boosting content satisfying a ranking condition among the specified contents, and providing, on a user terminal, items corresponding to each of the specified contents, wherein the providing includes displaying ranking-boosting information related to ranking-boosting on an item corresponding to the ranking-boosting content, among the items corresponding to each of the specified contents.

As described above, the methods and systems for providing contents according to some example embodiments provide an intuitive user environment that enables users to identify at a glance information on contents that are serialized on each day of the week by collecting and providing information on contents that are serialized on the basis of a day of the week on a specific service page.

Further, the methods and systems for providing contents according to some example embodiments can calculate a popularity ranking of serialized contents on every specific day of the week, and use the calculated popularity ranking to provide a user with information on popular contents.

### BRIEF DESCRIPTION OF THE DRAWINGS

FIG. 1 is a conceptual view for describing a system for providing contents according to an example embodiment.

FIG. 2A, FIG. 2B, and FIG. 2C are conceptual views for describing service pages provided by the system for providing contents, according to some example embodiments.

FIG. 3 is a flowchart for describing a method of providing contents according to an example embodiment.

FIG. 4A, FIG. 4B, and FIG. 4C are conceptual views for describing a page on which content information is provided, according to some example embodiments.

FIG. 5, FIG. 6A, FIG. 6B, FIG. 7A, FIG. 7B, FIG. 8A, and FIG. 8B are conceptual views for describing a method of selecting a ranking-boosting content that satisfies a desired (or alternatively, preset) condition, according to some example embodiments.

### DETAILED DESCRIPTION

Hereinafter, some example embodiments of the present inventive concepts will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the example embodiments disclosed in the present specification, the specific descriptions of publicly known related technologies will be omitted when it is determined that the specific descriptions may obscure the subject matter of the example embodiments disclosed in the present specification. In addition, it should be interpreted that the accompanying drawings are provided only to allow those skilled in the art to easily understand the example embodiments disclosed in the present specification, and the technical spirit disclosed in the present specification is not limited by the accompanying drawings, and includes all alterations, equivalents, and alternatives that are included in the spirit and the technical scope of the present inventive concepts.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

Some example embodiments of the present inventive concepts relate to methods for providing contents and systems for the same, in which information on contents may be provided to a user in various ways to effectively guide the user (consumer) to consume the contents.

As described in the present specification, the term “content providing service” may be understood to comprehensively include and refer to services provided by a system 100 for providing contents. The content providing service may be understood as providing a service for providing contents to a user terminal 200, as well as information related to the contents, and various functions necessary for using the contents.

Meanwhile, the system 100 for providing contents according to some example embodiments of the present inventive concepts may be configured as a system for providing at least one of various types of contents.

The types of contents to which the present inventive concepts may be applied may be very diverse. For example, at least one of contents such as comics, web novel, music, e-book, video, image, or the like may correspond to the contents provided by the present inventive concepts.

Meanwhile, in the present invention, the term “content” may also be referred to as “a piece of work”.

Hereinafter, for convenience of description, the content corresponding to comics will be used as an example.

The content may include at least one sub-content.

When the sub-content is provided in plural, a plurality of sub-contents may constitute a series of contents.

Here, the term “series” may mean a series of projects or contents.

In the present invention, the term “sub-content” may be referred to as “episode” to avoid confusion between the terms content and sub-content. That is, the terms “sub-content” and “episode” may be used interchangeably in the present specification.

Furthermore, in the present specification, “using (consuming or viewing) a content” may be understood as using (consuming or viewing) an episode (or a sub-content).

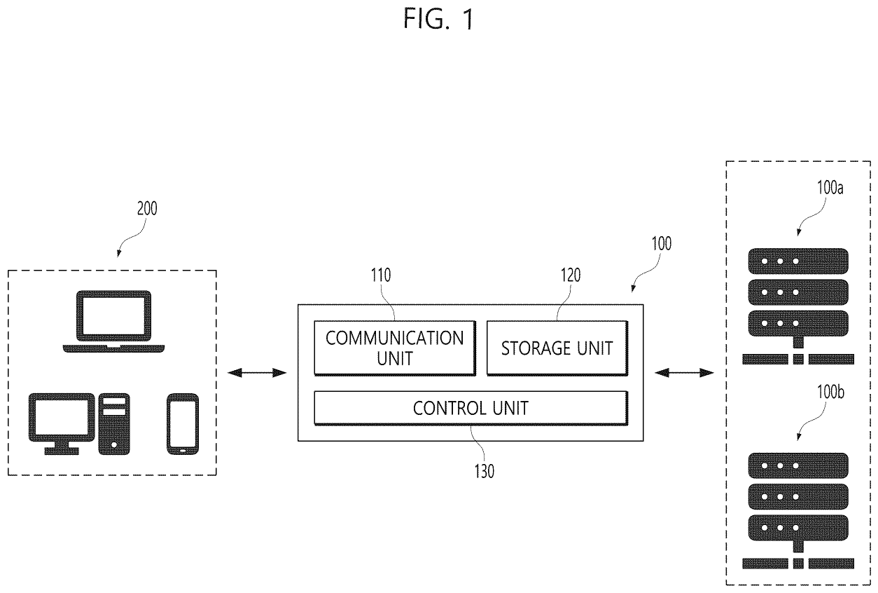

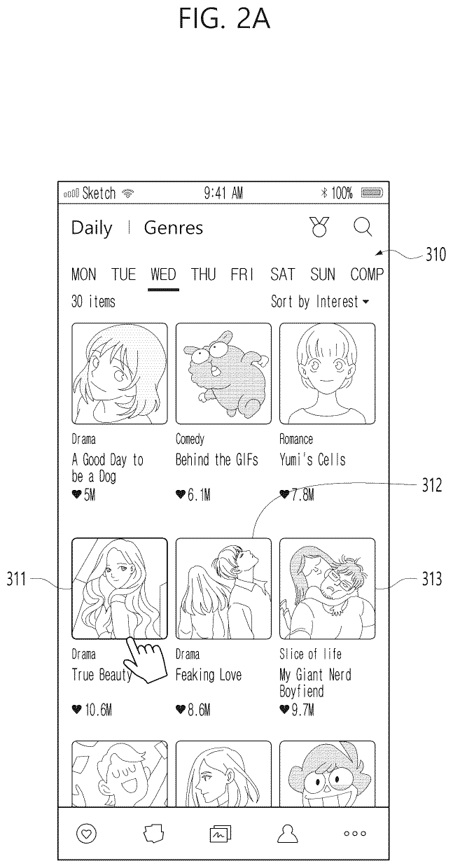

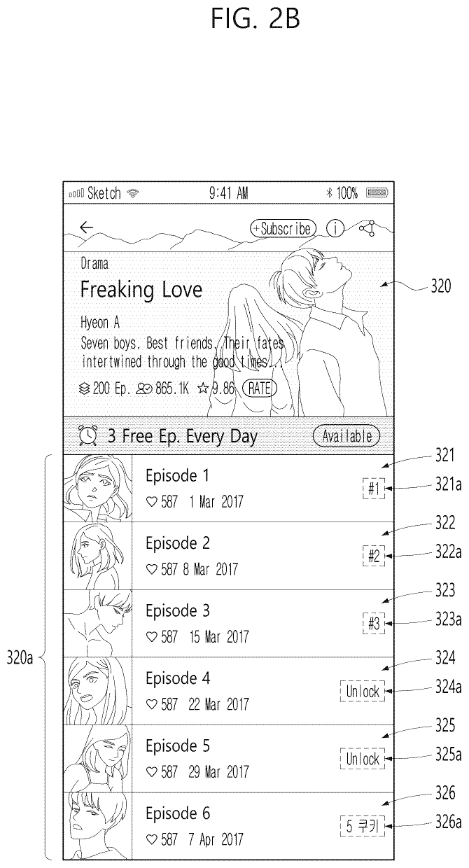

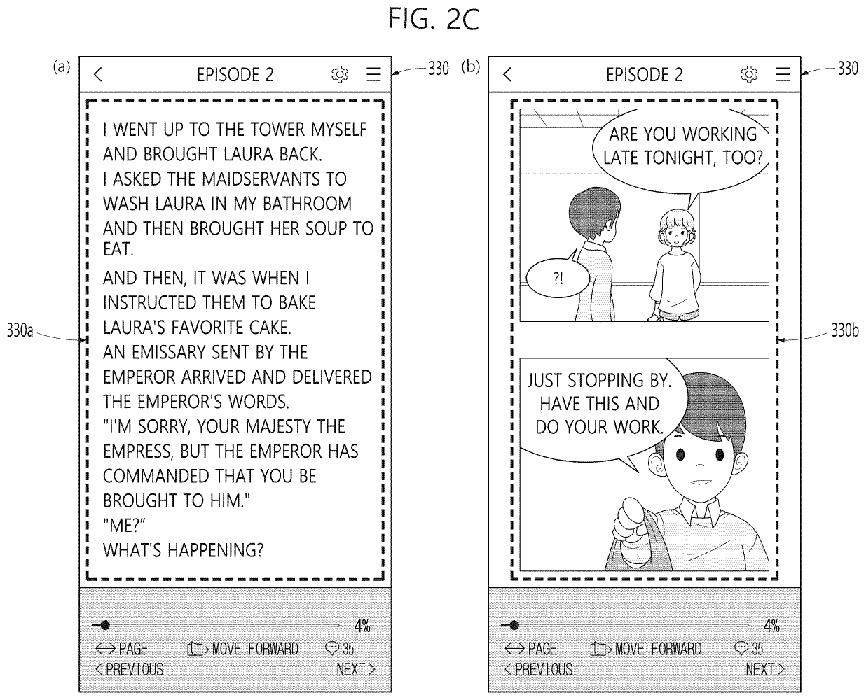

Hereinafter, the system 100 for providing contents will be described with reference to the accompanying drawings, and the content providing service provided by the system 100 for providing contents will be described in detail. FIG. 1 is a conceptual view for describing a system for providing contents according to an example embodiment, and FIG. 2A, FIG. 2B, and FIG. 2C are conceptual views for describing service pages provided by the system for providing contents, according to some example embodiments.

As illustrated in FIG. 1, the system 100 for providing contents may include at least one of a communication unit 110, a storage unit 120, and a control unit (or processing circuitry) 130.

Here, the communication unit 110 may perform a role of providing (or transmitting) contents or various information related to the contents to the user terminal 200 through wired or wireless communication.

As illustrated in FIG. 1, the user terminal 200 is not limited to any type of device, and may be a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)), and the like. In the present specification, the user terminal may be used interchangeably with a user terminal device, an electronic device, and the like.

Further, the communication unit 110 may receive a user input related to the content use from the user terminal 200. In the present specification, various services related to the content use may be provided to the user based on the user input received through the communication unit 110.

Next, the storage unit 120 may be configured to store various information related to the content use. The storage unit 120 may include at least one of a content server (content database (DB)) 100a that includes information on a plurality of contents or an artificial intelligence recommender server (AI recommender system and artificial intelligence recommendation database (DB)) 100b that includes information used to select user-customized recommended contents based on artificial intelligence.

The information related to the content providing service of the present inventive concepts may be stored in at least a portion of the content server 100a or the artificial intelligence recommendation server 100b, and the present invention does not place any special limitation on this method. Accordingly, hereinafter, the storage unit 120, content server 100a, and artificial intelligence recommendation server 100b may not be separately distinguished, and may be represented as the storage unit 120 or a database.

In addition, hereinafter, the content server and the content DB are not distinguished from each other and are collectively referred to as the content server, and the artificial intelligence recommendation server and the artificial intelligence recommendation DB are not distinguished from each other and are collectively referred to as the artificial intelligence recommendation server. That is, the content server described in the present specification can also be understood as the content DB, and the artificial intelligence recommendation server may of course be understood as the artificial intelligence recommendation DB.

Further, the content server 100a and the artificial intelligence recommendation server 100b, which store a plurality of contents, may exist in a separate configuration from the storage unit 120. In this case, the system 100 for providing contents according to the present inventive concepts may provide information stored in at least one of the content server 100a or the artificial intelligence recommendation server 100b to the user terminal 200.

Meanwhile, in the storage unit 120, history information associated with a user account subscribed to the content providing service according to the present inventive concepts may be stored.

Here, the term “history information” may include various information on a user account related to the content delivery service.

For example, the history information may include at least one of i) history information (e.g., a title of the content viewed, an episode number of the episode viewed, a date and time of viewing information) related to a content (or sub-content or episode) used (viewed or owned) by a user account (or the user terminal 200 to which the user account is logged in) and, ii) feedback information on the user account for a specific content (e.g., review information, comment information, rating information, reaction information on content recommendation (history of selecting an exit function icon in a pop-up window related to the specific content)), or iii) information related to an access pass (e.g., the number of access passes owned, types of access passes owned, types of access passes used, dates of access passes used, events for which access passes were awarded, etc.).

In some example embodiments of the present inventive concepts, a content that a user is interested in, which is based on preferences of the user, content usage (or consumption) patterns of the user, and the like, may be customized and recommended on the basis of history information matched to the user account. The user may easily select and use a content with reference to the recommended content.

In some example embodiments of the present inventive concepts, the system may include a history server (not illustrated, or a history DB (data base)), and history information may be stored in the history server (not illustrated), which includes various information related to an access pass assigned to a user account (or various information related to usage of the access pass).

A history server that stores a plurality of history information may be present as part of the storage unit 120, or may be present as a separate configuration from the storage unit 120. When the history server exists separately from the storage unit 120, the system 100 for providing contents may refer to the history server to recommend contents for the user account.

Further, the storage unit 120 may be configured to store a plurality of contents and information associated therewith that may be provided by the system 100 for providing contents according to some example embodiments of the present inventive concepts.

The information associated with the plurality of contents may include ranking information for each of the plurality of contents. The ranking information may be matched to the respective contents and stored in the storage unit 120.

The ranking information on contents may be stored as an accumulation of rankings (or ranking information) for each of a plurality of occasions on which the rankings were calculated. That is, the ranking of the contents may be managed as a ranking history, so that a history of changes in ranking may be identified.

The ranking of contents may be a ranking based on various references, and may be calculated according to, for example, a popularity ranking, a view count ranking, a payment ranking, and/or the like.

Next, the control unit 130 may perform a series of processes related to the content providing service, in which the control unit 130 may serve to control the previously described configurations.

For example, this role of the control unit 130 may be configured to be performed by at least one of the content server 100a or the artificial intelligence recommendation server 100b described above.

In an example, among the roles performed by the control unit 130, a series of processes of providing contents may be configured to be performed by the content server 100a and a series of processes of selecting user-customized recommended contents based on artificial intelligence may be configured to be performed by the artificial intelligence recommendation server 100b.

However, the present inventive concepts do not place any specific limitations on the subject performing the role related to the content providing service. Therefore, hereinafter, the control unit 130, content server 100a, and artificial intelligence recommendation server 100b may not be separately distinguished from each other, and may be expressed as the control unit 130 or as processing circuitry.

For example, a function that is described below as being performed by the control unit 130 may be performed by at least one of the content server 100a or the artificial intelligence recommendation server 100b.

Meanwhile, the control unit 130 according to some example embodiments may calculate a ranking for the contents provided through the system 100 for providing contents. As described above, the ranking of contents may be calculated on the basis of various references such as a popularity ranking, a payment ranking, a view count ranking, and the like.

The control unit 130 may calculate a ranking for each of a plurality of contents in units of a unit period of time. Here, the unit period of time is a period of time set under the control of an administrator or the control unit 130, and may be one week, for example. In this case, the control unit 130 may calculate a ranking of contents in units of one week.

Meanwhile, at least some of the contents according to some example embodiments may be uploaded (serialized) as episodes on every specific day of the week. For example, some of the contents registered with the system 100 for providing contents may be set to have episodes uploaded on Monday, and others may be set to have episodes uploaded on Tuesday.

Information on an upload reference for each of a plurality of contents may be stored to be matched to a corresponding one of the plurality of contents. The control unit 130 may, on the basis of this matching information, upload episodes for a content according to the upload reference. Here, the term “upload” may mean a state in which the corresponding episode is available to users of the content providing service. Meanwhile, the upload reference may be a reference to a day of the week on which a content is uploaded. The matching information may include information on a day of the week on which a matched content is uploaded. The control unit 130 may upload an episode of a content on a day of the week based on the matching information.

Meanwhile, the control unit 130 may calculate a ranking of contents on a specific day of the week that is specified for the content to be uploaded. For example, when a first content exists and is set to be uploaded on Wednesday, the control unit 130 may calculate a ranking of the first content on Wednesday, which is the present occasion on which the first content is uploaded.

For another example, when a second content exists and is set to be uploaded on Thursday, the control unit 130 may calculate a ranking of the second content on Thursday, which is the present occasion on which the second content is uploaded.

Meanwhile, the control unit 130 may set various comparison subjects for calculating a ranking.

In an example, the control unit 130 may calculate a relative ranking among all contents registered with the system 100 for providing contents. For example, when there are 100 contents registered with the system 100 for providing contents, and a ranking of a specific content corresponding to a subject for ranking calculation is to be calculated with reference to the popularity of the contents, the control unit 130 may calculate what the “popularity” of the specific content is among the 100 contents.

In another example, the control unit 130 may calculate a ranking among contents that are serialized on every specific day of the week, rather than all contents registered with the system 100 for providing contents. For example, when there are 30 contents being serialized on a specific day of the week among the contents registered with the system 100 for providing contents, the control unit 130 may calculate rankings of the 30 contents. When calculating a ranking among the contents with reference to the popularity of the contents, the control unit 130 may calculate what the “popularity” of the specific content is among the 30 contents. In this case, the ranking of the specific content may be a popularity ranking within the contents that are serialized on the specific day of the week (e.g., Thursday).

As described above, the control unit 130 may calculate a ranking of the contents provided by the system 100 for providing contents and effectively provide information on the calculated ranking to users, thereby providing users with a guide for selecting contents.

Meanwhile, as illustrated in FIGS. 2A, 2B, and 2C, for the content providing service, the control unit 130 may control such that one of a plurality of service pages (or which may be referred to as “screens”, 310, 320, and 330) including information related to the contents is output on the user terminal 200.

As such, the service pages 310, 320, and 330 may be controlled to be output on the user terminal 200 through an application. In this case, the application may perform at least some of the functions described above that are performed by the system 100 for providing contents.

As for the service pages 310, 320, and 330, various service pages may be present depending on the kind of information included in each service page 310, 320, or 330, a function that is performed, and the control unit 130 may provide a specific service page to the user terminal 200 on the basis of any one of the various service pages 310, 320, and 330 being called.

For example, the plurality of service pages may include, i) a page that is provided as a default in using the content providing service (which may be referred to as a “default service page”, “main page”, ”“home screen”, and the like, 310 in FIG. 2A), ii) a page that includes an episode list for items corresponding to a plurality of episodes constituting a specific content (which may be referred to as a “content entry page”, “episode list page”, 320 in FIG. 2B), iii) a page that provides a specific episode of a content (which may be referred to as a “content providing page”, 330 in FIG. 2C), vi) a page that provides information related to a user account (which may be referred to as a “user page”, not illustrated), v) a page that includes an access pass issuance service function (not illustrated), vi) a page that includes a digital currency charging service function (not illustrated), and the like.

Further, in the present specification, a service page more directly related to content provision such as the “content entry page 320” and the “content providing page 330” may be referred to as a “content page”. That is, the “content page” may be understood as a page that provides various functions related to content provision, in addition to one of the “content entry page 320” or the “content providing page 330” described above.

Meanwhile, the service pages listed above are only for illustrative purposes, and a service page according to some example embodiments of the present inventive concepts may include various service pages that include some desired information or perform functions in relation to the content providing service.

The control unit 130, upon receiving a request for a specific service page from the user terminal 200, may control such that the requested specific service page is output on the user terminal 200.

For example, the control unit 130 may provide a service page (the default service page 310), illustrated in FIG. 2A, on the user terminal 200 when an application is executed or a user input to a specific icon (e.g., “home button”) is applied. This default service page 310 may include information related to at least one content 311, 312, or 313 provided by the content providing service (e.g., a thumbnail, a title, an author's name, views, a recommended content, and the like).

The user may select an area corresponding to information related to a specific content 311 on the default service page 310 to request viewing of the specific content 311.

That is, a viewing event (or viewing request) for a content may occur on the basis of an operation at which the specific content 311 is selected on the user terminal 200.

The control unit 130 may receive, through the communication unit 110, a viewing event (or viewing request) for the specific content 311 from the user terminal.

Meanwhile, when the system for providing contents according to an example embodiment is an application, the communication unit 110 may perform a role of an interface unit that receives a selection signal from the user terminal 200. That is, when the specific content 311 is selected by the user on the user terminal 200, the communication unit 110 may perform a role of receiving a selection signal corresponding to the user's selection on the user terminal 200.

Meanwhile, upon receiving a viewing request for a specific content from the user terminal 200, the control unit 130 may provide the content entry page 320 on the user terminal, which includes an episode list 320a for a plurality of episodes constituting the specific content, as illustrated in FIG. 2B.

As illustrated in FIG. 2B, the episode list 320a may include a plurality of episode items 321 to 326.

In this case, the plurality of episode items 321 to 326 are configured to correspond to a plurality of episodes constituting a specific content, respectively.

The control unit 130, upon receiving a selection for the specific content 311, as illustrated in FIG. 2A, may provide the list 320a that includes a plurality of episode items corresponding to a plurality of episodes included in the specific content on the user terminal 200 on the basis of the selection, as illustrated in FIG. 2B.

The user may select an area corresponding to information related to the specific content 311 on the content entry page 320 to request viewing of a specific episode (e.g., “second episode” or “Episode 2”, 322).

The control unit 130 may determine that a viewing event for a specific episode of a specific content (e.g., episode 2 of “Freaking Love”) has occurred on the basis of a viewing request for the specific episode of the specific content received from the user terminal 200.

As illustrated in FIG. 2C, the control unit 130, on the basis that a viewing event has occurred for a specific episode of a specific content, may provide the content providing page 330 including episode content information 330a and 330b corresponding to the content of the specific episode to the user terminal 200.

According to some example embodiments, the episode content information 330a and 330b, may be understood as information that is produced and processed in a digital manner, such as a text, a symbol, a voice, an image, a video, and/or the like, to provide content corresponding to an episode.

In an example, the episode content information 330a of a novel content, as illustrated in (a) of FIG. 2C, may be understood as information comprising a text, an illustration image, and/or the like.

In another example, as illustrated in (b) of FIG. 2C, episode content (or episode content information) 330b of a comics content may be understood as information comprising at least one of a still image, a dynamic image (video), a text, and/or the like.

In the present invention, the term “episode content” may be used interchangeably with “content of a sub-content”.

Meanwhile, the control unit 130, on the basis of a viewing request for the specific episode 311 of the specific content received from the user terminal 200, may determine whether the user logged into the user terminal 200 has a viewing permission for the specific episode 311 for which the viewing request is made.

A viewing permission of a user for a specific episode may be related to a product type of the specific episode.

According to some example embodiments, an episode to be provided may be a “free product type” or a “paid product type”.

An “episode with a free product type” may mean an episode that is immediately available to a user without paying, for example, digital currency, a coupon, or a viewing pass (or access pass), in order to view (or use) the episode.

The control unit 130 may determine that a viewing permission of a specific episode exists in a user account logged into the user terminal 200 when a product type of the specific episode for which a viewing request is made corresponds to a free product type, and may provide the specific episode (or episode information) through the user terminal 200.

In contrast, an “episode with a paid product type” may mean an episode that is only available when a user pays using, for example, digital currency, a coupon, or an access pass (or viewing pass), in order to view (or use) the episode.

The control unit 130 may determine whether digital currency, an access pass, or the like exists in a user account logged into the user terminal 200 for viewing a specific episode when a product type of the specific episode for which a viewing request is determined to be a paid product type, determine that a viewing permission exists in the user account, and provide the specific episode (or episode information) through the user terminal 200.

Here, the term “access pass (or viewing pass)” may be understood as being used to view (rent or own) an episode with a paid product type that is provided by the system 100 for providing contents, without making a payment of digital currency. The access pass described in the present specification may be used interchangeably with a (free) ownership pass, a (free) rental pass, a coupon, and the like.

The control unit 130 may grant (assign or provide) an access pass to a user account on the basis of a specific event.

The event for granting the access pass may be set by an administrator of the system 100 for providing content, or may be set by the control unit 130 on the basis of user history information associated with the user account. In an example, the control unit 130 may grant an access pass to a user account through a specific service page at a desired (or alternatively, preset) time (e.g., 10:00 p.m. every night).

The control unit 130 may provide (issue, grant, or assign) an access pass to a user account by storing the access pass (or information related to the access pass) in the storage unit 120 in association with the user account.

Meanwhile, the term “digital currency” is a form of currency that is used in a digital manner (stored to be used on a computer or used over a network) and may also be referred to as “cyber money”. This digital currency may mean currency whose monetary value is stored in an electronic form.

The digital currency may be stored in an electronic form on the control unit 130 or a server in conjunction therewith.

The digital currency may be stored in conjunction with a user account. That is, digital currency equivalent to the amount purchased by a user may be present in conjunction with a user account.

The digital currency is used for economic consumption activities, and an example of digital currency may also include social currency, an Internet coupon, a mobile coupon, game money, and the like.

Meanwhile, the places where the digital currency can be used may vary, depending on a service provider issuing the digital currency.

For example, digital currency issued by Company A may only be used on a service platform provided by Company A (e.g., shopping mall A). In addition, when there is a plurality of service platforms operated by Company A, the digital currency issued by Company A may be used in common on the plurality of service platforms in accordance with the policy of Company A.

In addition, the digital currency may be used in common across service platforms of different service providers, or by partnerships between the service providers.

Further, the digital currency may be referred to as various terms and may be referred to by the service provider. For example, the digital currency may be referred to as a nut, a bean, an acorn, a cone, and the like. In the present specification and drawings, this digital currency is referred to as a “cookie” (or coin). Accordingly, in the present specification, the term “cookie” is used interchangeably with the term digital currency, and the term “cookie” is to be understood as digital currency.

Meanwhile, the digital currency may be purchased by an electronic settlement (payment)

As described in the present specification, the “electronic settlement (payment)” means paying for the purchase of goods or services by a user (or consumer) using the user terminal 200 to which a program or function that enables transactions for currency having a monetary value is connected.

This electronic settlement may be understood to mean that the payment is made online, which includes a card payment, a loyalty payment, a wire transfer, and the like.

Meanwhile, in the present specification, “digital currency is purchased through an electronic settlement” may be expressed as “digital currency is charged”. That is, a user may “purchase” or “charge” digital currency by the electronic settlement. The digital currency purchased or charged as described above may be present in conjunction with a user account.

Meanwhile, the control unit 130 may control such that the product type information 321a to 326a of the episodes is included in the episode list 320a output on the user terminal 200, thereby enabling a user to intuitively recognize the product type of the episode.

The control unit 130 may output the product type information (or graphic object, 321a to 326a) of the episode to one area of each of the episode items 321 to 326 constituting the episode list 320a, depending on the product type of the episode.

First, the control unit 130 may allow the items 321, 322, and 323 corresponding to episodes of a free product type to include first information 321a, 322a, 323a, and “#” indicating that the corresponding episode is free. The control unit 130 may not determine whether a user account has an access permission (access pass or digital currency) when a viewing request is made for an episode with a free product type.

Next, the control unit 130 may allow the episode items 324 and 325, which correspond to episodes of a paid product type and for which a paid episode viewing pass is available, to include second information 324a and 325a (e.g., an “unlock”) that is different from the first information.

As described above, the control unit 130 may allow a graphic object that indicates that the paid episode viewing pass assigned to the specific user account is available to be included in one area of the item corresponding to an paid episode.

Further, the control unit 130 may allow the episode item 326 corresponding to an episode of a paid product type that is not available for use of a paid episode viewing pass to include third information 326a that is different from the first and second information. Here, the third information may include payment amount information (or electronic currency information, e.g., 5 cookies or 5 coins) for which the corresponding paid episode is available for purchase.

Further, although not illustrated, the control unit 130 may control such that state information of an episode is output in an area where the product type information 321a to 326a of the episode is output. In some example embodiments, the control unit 130, on the basis of history information of a user account, may include at least one of information indicating whether a history of using an access pass for a specific episode exists (e.g., “used”), information indicating that the specific episode is a paid episode that has already been purchased (viewed or used) (e.g., “purchased”), or information indicating a duration of use (or expiration date) for the specific episode (e.g., “1day(s) left”).

As described above, the control unit 130 may display product type information or state information of the corresponding episode to each of the items corresponding to the episode. Therefore, a user may intuitively predict what access condition or access permission is desired when the user wants to use the corresponding episode, just with the information included in an episode list.

According to some example embodiments, methods and systems for providing contents may more effectively provide various information on contents, and may provide a user environment that enables a user to identify information on contents that are serialized every specific day of the week at a glance.

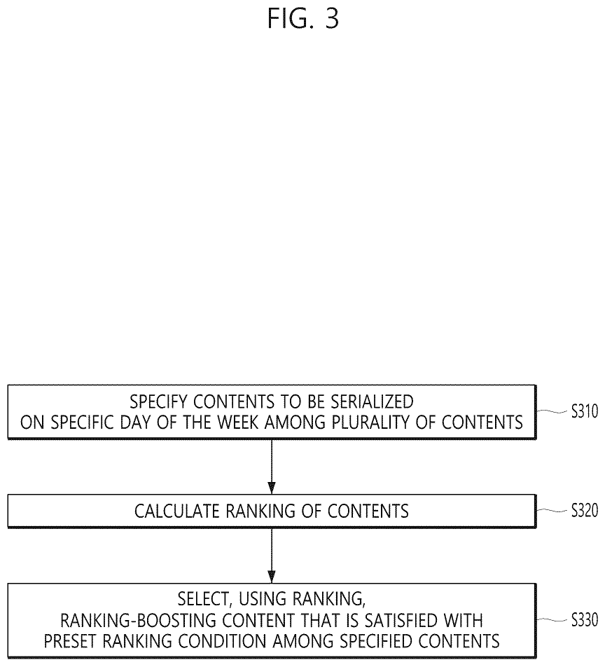

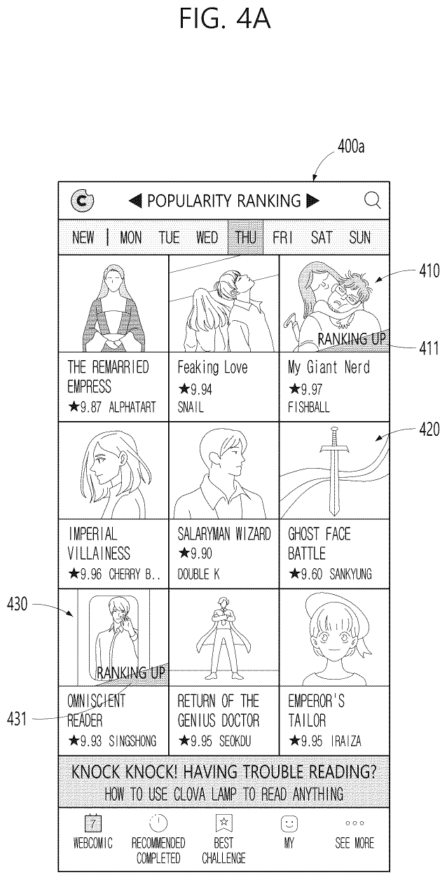

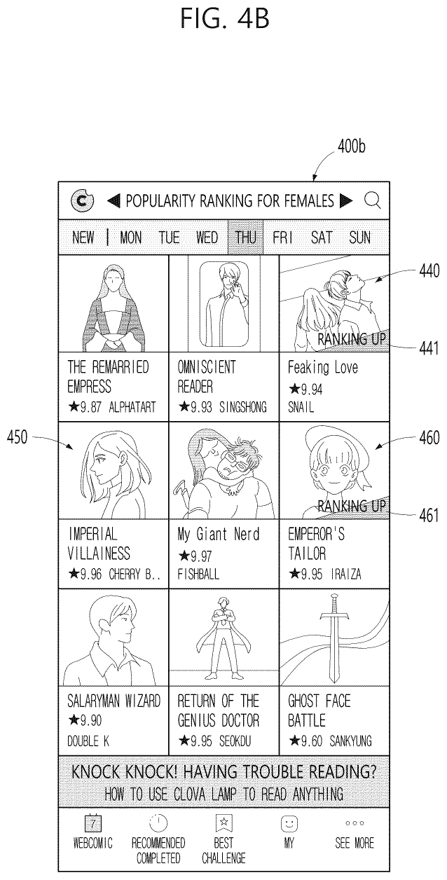

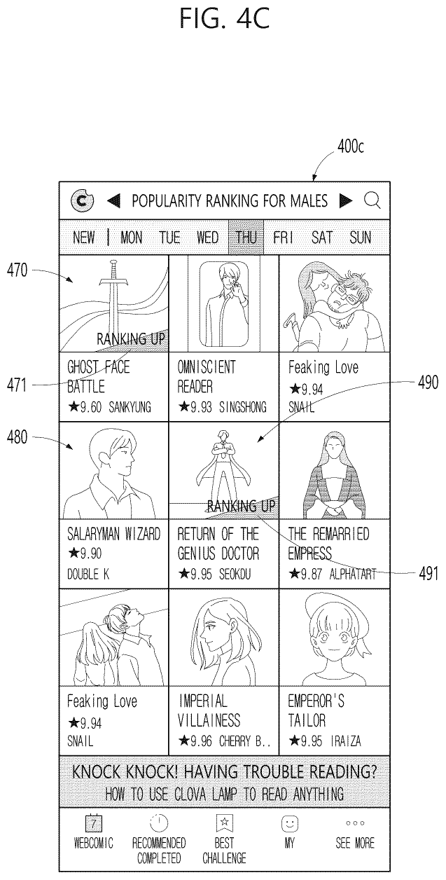

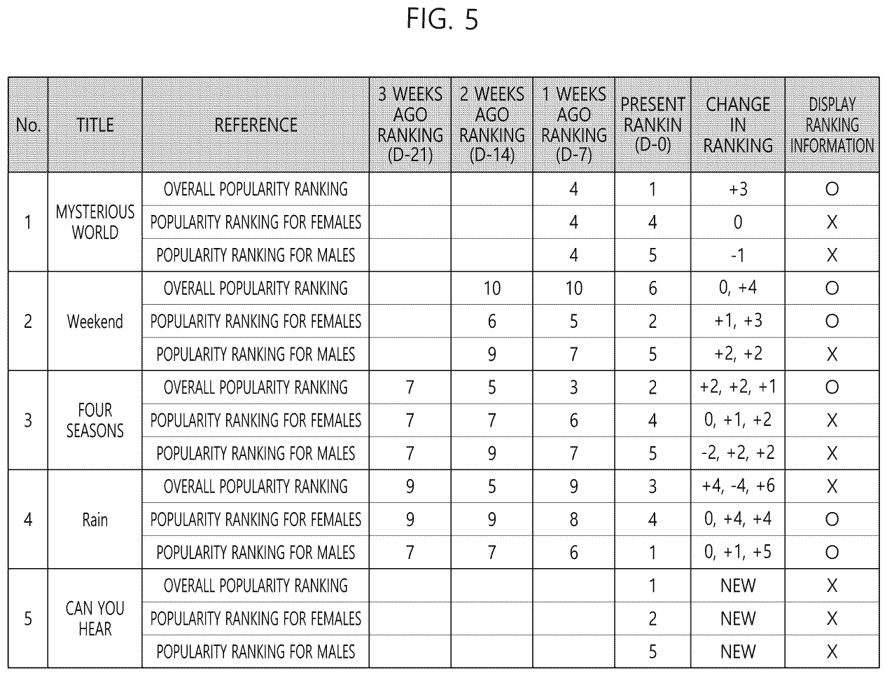

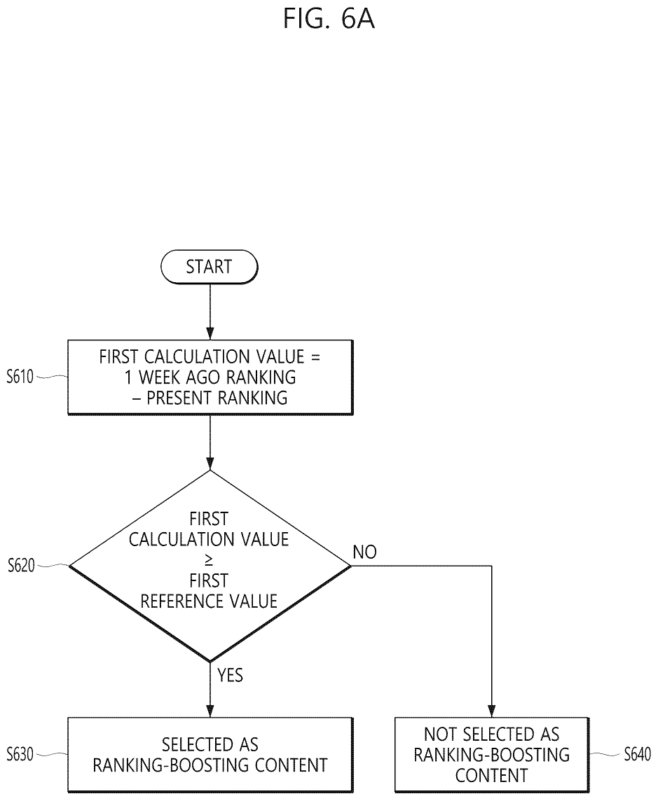

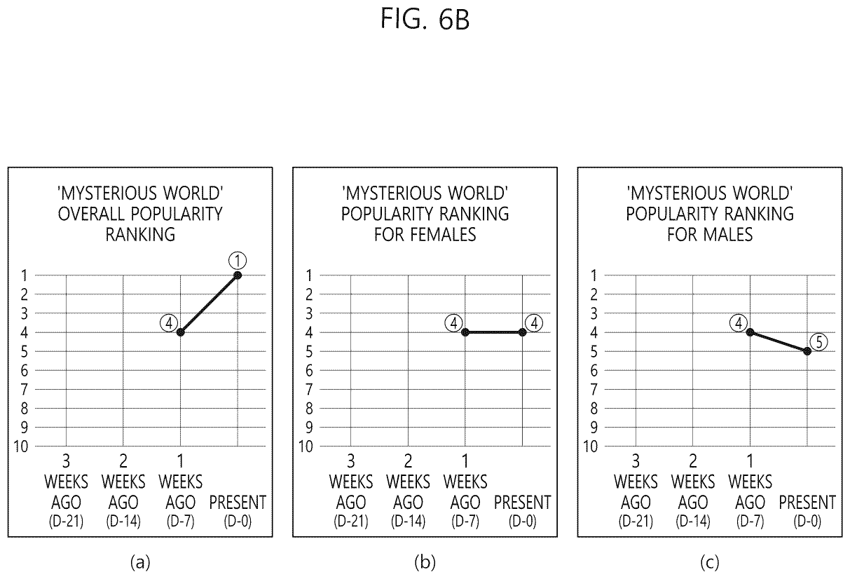

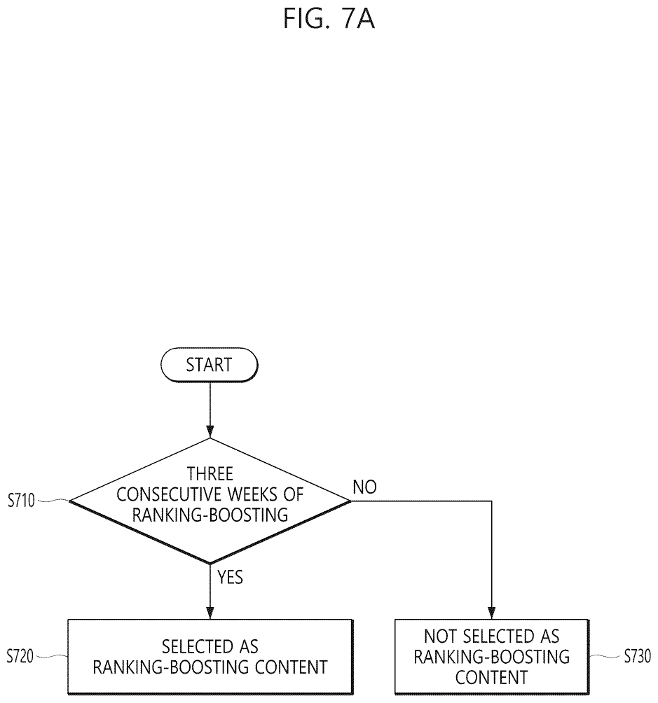

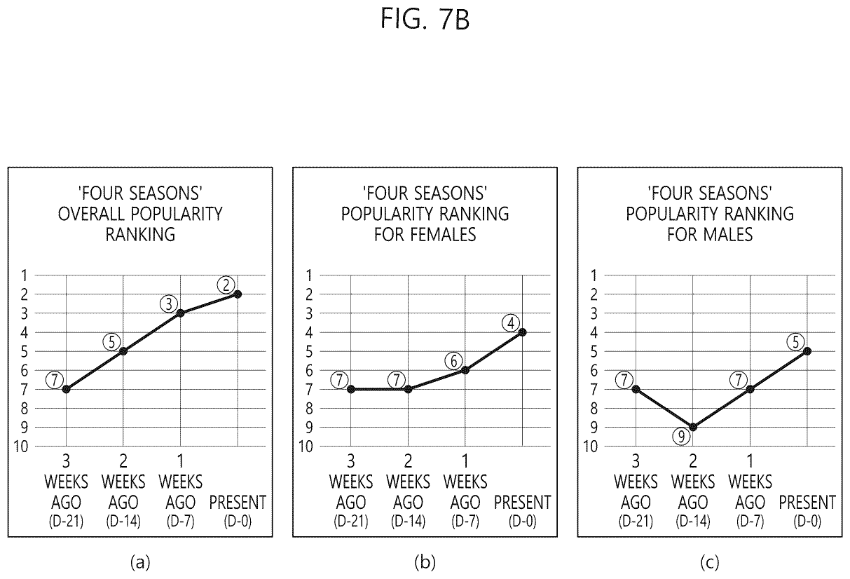

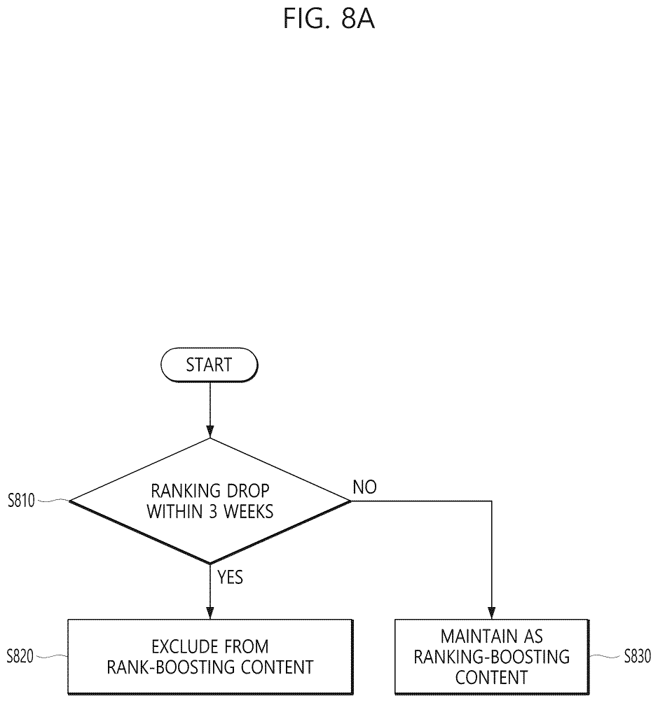

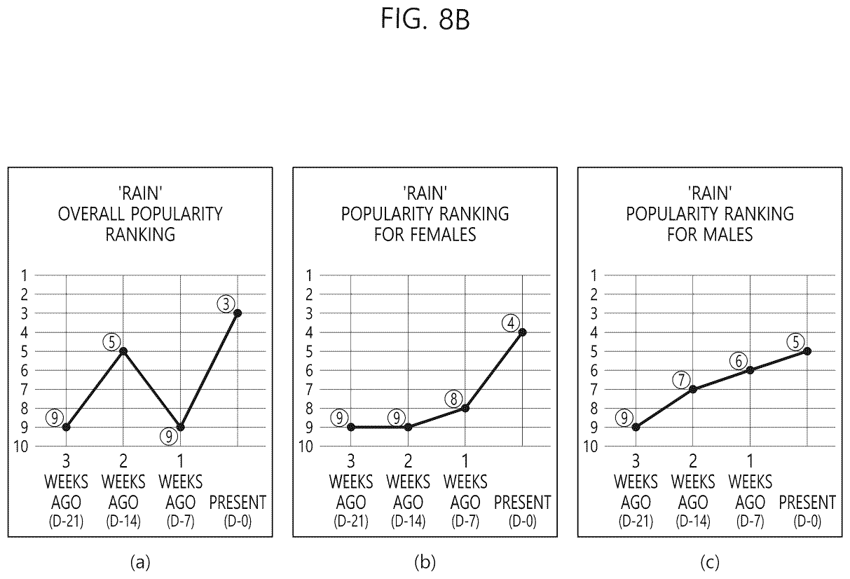

Hereinafter, some example embodiments of the present inventive concepts will be described in more detail with reference to the accompanying drawings. FIG. 3 is a flowchart for describing a method of providing contents according to an example embodiments, and FIG. 4A, FIG. 4B, and FIG. 4C are conceptual views for describing a page on which content information is provided, according to some example embodiments. FIG. 5, FIG. 6A, FIG. 6B, FIG. 7A, FIG. 7B, FIG. 8A, and FIG. 8B are conceptual views for describing a method of selecting a ranking-boosting content that satisfies a desired (or alternatively, preset) condition, according to some example embodiments.

First, in the method of providing contents of the content providing service according to an example embodiment, a process of specifying contents to be serialized on a specific day of the week among a plurality of contents available through the system for providing contents may proceed (S310).

The system for providing contents according to an example embodiment may upload episodes of different contents on every specific day of the week, and may therefore, guide a user to use the content providing service on various days of the week.

Information on contents may be present to be stored in the storage unit 120, with new episodes being serialized (or uploaded) on different days of the week. For example, serialization information on contents in a first group for which a new episode is serialized (or uploaded) on Monday, serialization information on contents in a second group for which a new episode is serialized (or uploaded) on Tuesday, serialization information on contents in a third group for which a new episode is serialized (or uploaded) on Wednesday, serialization information on contents in a fourth group for which a new episode is serialized (or uploaded) on Thursday, serialization information on contents in a fifth group for which a new episode is serialized (or uploaded) on Friday, serialization information on contents in a sixth group for which a new episode is serialized (or uploaded) on Saturday, and serialization information on contents in a seventh group for which a new episode is serialized (or uploaded) on Sunday, may be stored in the storage unit 120. Hereinafter, the terms “serialization” or “upload” will be used uniformly to be referred to as “serialization”.

As described above, the serialization information on contents for which new episodes are serialized on corresponding days of the week may be stored in the storage unit 120, and the control unit 130 may specify contents to be serialized on a specific day of the week on the basis of such serialization information.

Meanwhile, the occasions that specify contents to be serialized on a specific day of the week may vary widely. For example, the control unit 130 may specify contents to be serialized on a specific day of the week, with reference to a desired (or alternatively, preset) time. Here, the preset time may correspond to 00:00 (hour:minute) every day, which is an occasion when the date is switched.

In another example, an occasion for specifying a content serialized on a specific day of the week may correspond to a time when a request for information on the content serialized on a specific day of the week is received from the user terminal. The control unit 130 may specify a content to be serialized on a specific day of the week, on the basis of a user request received through a webpage or application providing the content providing service.

In still another example, specifying content to be serialized on a specific day of the week may be made on the basis that a day of the week on which the content is to be serialized is set by the administrator.

Meanwhile, specifying a content to be serialized on a specific day of the week may be used to categorize and provide contents with reference to a day of the week on which a new episode is serialized. That is, the control unit 130 may collect contents having new serialized episodes for each day of the week and provide the contents to users. Therefore, the users may be collectively provided with information on newly serialized contents for each day of the week through a single page corresponding to each day of the week.

In the content providing service according to some example embodiments, a plurality of service pages matched to different days of the week may be provided. The control unit 130 may provide a page matched to the specific day of the week to the user terminal when receiving a selection for the specific day of the week from the user terminal. Further, the control unit 130 may provide information on the contents for which a new episode is being serialized on the specific day of the week to the matched page.

That is, the control unit 130 may provide an item (or list) corresponding to each of the contents specified as having a new episode serialized on the specific day of the week, on a specific service page matched to the specific day of the week, among a plurality of service pages matched to different days of the week.

Meanwhile, the control unit 130 may provide the user terminal with a service page that includes information on contents for which new episodes are being serialized on a specific day of the week when a menu that provides information on newly serialized episodes for each day of the week is selected from the user terminal among the menus of the content providing service. In this case, the control unit 130 may first provide the user terminal with a page on a day of the week corresponding to an occasion on which the menu is selected, among the service pages matched to different days of the week. For example, when the occasion on which the menu is selected is “Wednesday”, the control unit 130 may provide the user terminal with a service page that collects information on contents for which new episodes are serialized on Wednesday.

The control unit 130 may separate the information on the contents for each day of the week, on the basis of the serialization information on the contents in the first to seventh groups described above, and provide the information to the user terminal.

Next, a process of calculating a ranking of contents may proceed (S320). The control unit 130 may calculate a ranking of contents on the basis of various references.

In this case, “what” a ranking of contents is for may be set in a variety of ways. For example, a ranking of contents may be a “popularity ranking” of contents. That is, the control unit 130 may calculate a popularity ranking of contents, thereby providing a user with information on the contents according to an order of popularity.

A reference to a “popular” content may be defined in various ways. For example, a popular content may be determined on the basis of various determination indicators, such as the number of views by users, the number of payments made, or the payment amount paid, in the content providing service. In the present specification, no particular restrictions are placed on the indicator that calculates “popularity” and it is assumed that a desired (or alternatively, preset) determination indicator exists.

Meanwhile, in the present invention, it for example, in addition to the “popularity ranking”, the ranking of contents may be a ranking on various references, such as an update ranking, a star rating ranking (or an evaluation score ranking), a viewing ranking, or the like. Hereinafter, for convenience of description, descriptions will be described with reference to “popularity ranking”, but the corresponding reference may be modified to various references.

Meanwhile, when specifying a ranking among contents, the control unit 130 may specify a group of comparison subjects of the ranking calculation in various ways.

In an example, the control unit 130 may calculate a relative ranking among all contents registered with the system 100 for providing contents. For example, when all the contents registered in the system 100 for providing contents are 100, and a ranking is calculated with reference to the popularity of the contents, the control unit 130 may calculate a popularity ranking among the 100 contents.

In another example, the control unit 130 may calculate a ranking among contents that are serialized on every specific day of the week, rather than all contents registered with the system 100 for providing contents. For example, when there are 30 contents being serialized on a specific day of the week among the contents registered with the system 100 for providing contents, the control unit 130 may calculate a ranking of the 30 contents.

As described above, the control unit 130 may set a range that includes subjects of the ranking calculation in various ways. A first range may correspond to all the contents that may be provided through the content providing service described earlier, and a second range may correspond to contents for which new episodes are serialized on a specific day of the week. In this case, the control unit 130 may calculate a ranking of contents in different ranges that are categorized for different days of the week.

Meanwhile, in calculating a popularity ranking of contents, the control unit 130 may calculate the popularity ranking with reference to different categorization subjects. In this case, the categorization subject is one that is categorized with reference to the characteristics of a user who is using the contents, which may be various indicators that can distinguish the characteristics of the user, such as the user's gender, age (age range), occupation, and the like.

For example, the control unit 130 may calculate an integrated popularity ranking of contents without distinguishing between subjects, as illustrated in FIG. 4A. In this case, the control unit 130 may calculate a popularity ranking of the contents for all users.

In another example, the control unit 130 may calculate a popularity ranking of a specific subject, as illustrated in FIGS. 4B and 4C, with reference to a specific subject (e.g., female or male). For example, the control unit 130 may calculate a popularity ranking for females for all the contents or for each of the contents that are serialized on a specific day of the week. In still another example, the control unit 130 may calculate a popularity ranking for males for all the contents or for each of the contents serialized on a specific day of the week.

Therefore, even if the types of the contents provided on a service page are the same, the position or order in which the items corresponding to the contents are arranged on the service page may be different depending on which reference has been used to calculate the popularity ranking.

For example, a service page that is matched for each day of the week may provide information on contents that have new episodes serialized for each day of the week. For example, on a specific service page that is matched to a specific day of the week, items may be provided that correspond to contents that are specified as being serialized on the specific day of the week. In this case, on the specific service page matched to the specific day of the week, the items corresponding to the contents specified as being serialized on the specific day of the week may, on the basis of one of a plurality of sorting references, be disposed sequentially according to a popularity ranking according to the one of the sorting references.

Here, the plurality of sorting references may mean a subject that has been taken into consideration to calculate the popularity ranking described above. For example, a first reference of the plurality of sorting references may correspond to an integrated popularity ranking that does not distinguish between subjects, a second reference may be a popularity ranking for females, and a third reference may be a popularity ranking for males.

Meanwhile, the control unit 130 may provide items corresponding to contents for each popularity ranking according to a sorting reference selected by a user request on service pages 400a, 400b, and 400c, as illustrated in FIG. 4A, FIG. 4B, and FIG. 4C.

As illustrated in FIG. 4A, items corresponding to contents (e.g., 410, 420, and 430) may include information related to the contents. The information related to a content may include at least one of an image (or thumbnail image) corresponding to the content, a title of the content, an author, or a rating.

Using the ranking calculated in step S320, a process of selecting a ranking-boosting content satisfying a desired (or alternatively, preset) ranking condition (or a desired (or alternatively, preset) ranking-boosting condition) may proceed (S330).

As described above, when providing the items corresponding to the contents to the service page, the control unit 130 may allow ranking-boosting information to be further included in an item corresponding to a content selected as a ranking-boosting content. In this case, the information related to the content may further include ranking-boosting information. The control unit 130 may output ranking-boosting information to an item of a content in which the ranking-boosting information exists.

For example, as illustrated in FIG. 4A, the control unit 130 may select a content satisfying a desired (or alternatively, preset) ranking condition as a ranking-boosting content among the contents for which new episodes are serialized on a specific day of the week (e.g., Thursday), and allow ranking-boosting information 411 or 431 to be further included in the item (e.g., 410 or 430) corresponding to the selected ranking-boosting content. That is, the ranking-boosting information 411 or 431 may be further included in the item 410 or 430 of the content selected as a ranking-boosting content, whereas ranking-boosting information is not included in the item 420 of the content that is not selected as a ranking-boosting content.

Because the reference of calculating a popularity ranking may vary depending on the subjects, the content that satisfies the desired (or alternatively, preset) ranking condition may also vary depending on the subjects. For example, as illustrated in FIG. 4B and FIG. 4C, a popularity ranking for a first subject (e.g., “female”) and a popularity ranking for a second subject (e.g., “male”) may be different, in which case content subjects that satisfy the desired (or alternatively, preset) ranking condition may also be different. For example, in case of the first subject (e.g., female), the contents of the item corresponding to reference numerals of 440 and 460 may be the contents that satisfy the desired (or alternatively, preset) ranking condition, and in case of the second subject (e.g., male), the contents of the item corresponding to reference numerals of 470 and 490 may be the contents that satisfy the desired (or alternatively, preset) ranking condition.

Meanwhile, the ranking-boosting information may be represented in a variety of ways, and may be expressed as a graphic object, which is a visual image. In this case, the graphic object (e.g., 411, see FIG. 4A) may be configured to overlap at least a portion of the item corresponding to a ranking-boosting content (e.g., 410, see FIG. 4A), as illustrated. The graphic object corresponding to the ranking-boosting information may include guidance information indicating a reason the ranking-boosting content selected as a ranking-boosting content has been selected as a ranking-boosting content. For example, the guidance information may include a reason why a content has been selected as a ranking-boosting content, such as how many steps of ranking the content has boosted (e.g., 3 ranking spikes!), over what period of time (e.g., 3 weeks in a row!) the ranking of the content has been continuously boosted (e.g., 3 weeks in a row!), and the like.

As described above, the control unit 130 may sort the items of contents by a specific reference when providing the items of contents on the service page, and the specific reference in this case may be, for example, a popularity ranking for each of the contents.

Meanwhile, the control unit 130 may select a content satisfying the ranking-boosting condition as a ranking-boosting content when a ranking (e.g., a popularity ranking) calculated for each of the contents satisfies the desired (or alternatively, preset) ranking condition. Further, the control unit 130 may display a graphic object on an item of the content selected as a ranking-boosting content, indicating that the corresponding content is a ranking-boosting content that satisfies the desired (or alternatively, preset) ranking condition.

Meanwhile, the control unit 130 may calculate a ranking for each of the different references (e.g., overall popularity ranking, popularity ranking for females, popularity ranking for males) as illustrated in FIG. 5, and determine, for each reference, whether the ranking of the corresponding content satisfies the ranking-boosting condition. For example, the control unit 130 may determine whether a content (a piece of work) corresponding to the “Mysterious World” satisfies the desired (or alternatively, preset) ranking condition in each of the overall popularity ranking with reference to all users, the popularity ranking for females with reference to female users, and the popularity ranking for males with reference to male users. Further, using the results of the determination, whether ranking-boosting information is further included in the item for the corresponding content (e.g., “Mysterious World”) on the service page sorted by each reference may be determined. For example, when the corresponding content satisfies the desired (or alternatively, preset) ranking condition in the overall popularity ranking, on a service page where items corresponding to the contents are sorted by the overall popularity ranking, an item corresponding to the content (e.g., “Mysterious World”) may further include ranking-boosting information.

Hereinafter, assuming that a ranking of contents has been calculated on the basis of one of the various references, a method (or logic) of selecting a ranking-boosting content that satisfies the desired (or alternatively, preset) ranking condition will be described more specifically.

According to some example embodiments, the desired (or alternatively, preset) ranking condition may relate to whether a popularity ranking of contents on a plurality of different occasions has been boosted. For example, the desired (or alternatively, preset) ranking condition may be a condition related to whether a popularity ranking of contents has been boosted by a desired (or alternatively, preset) range or more, when a specific occasion on which the popularity ranking of contents is calculated is compared to a past occasion of at least one unit period of time with respect to the specific occasion. In other words, the desired (or alternatively, preset) ranking condition may be related to whether the popularity ranking of each of the specified contents has been boosted by a range or more between a specific occasion on which the popularity ranking of each of the specified contents is calculated and a past occasion on which the popularity ranking of each of the specified contents is calculated, the past occasion being at least one unit period of time prior to the specific occasion.

Here, a content that is a subject of being determined to satisfy the desired (or alternatively, preset) ranking condition may be a content that is specified under the control of the control unit 130 or an administrator, or may be a content that is specified to have a new episode serialized with respect to a specific day of the week.

The control unit 130 may specify contents to be provided on the same service page in order to collect and display items of contents on the service page, and determine whether the specified contents satisfy the desired (or alternatively, preset) ranking condition. For example, items of contents that are included on the same service page may correspond to items of contents that are serialized on the same day of the week. In this case, the control unit 130 may determine whether a content satisfying the desired (or alternatively, preset) ranking condition exists among the contents serialized on the same day of the week. As described above in FIG. 5, the control unit 130 may determine whether the contents satisfy the desired (or alternatively, preset) ranking condition for each reference (e.g., overall popularity ranking, popularity ranking for females, popularity ranking for males).

Meanwhile, when a popularity ranking of contents (or a specified content) at a specific occasion has been boosted by the desired (or alternatively, preset) range or more compared to the popularity ranking at the past occasion, the control unit 130 may select the content whose ranking has been boosted by the desired (or alternatively, preset) range or more as a ranking-boosting content.

Further, when a popularity ranking of contents (or a specified content) at a specific occasion has not been boosted by the desired (or alternatively, preset) range or more compared to the popularity ranking at the past occasion, the control unit 130 may not select the content whose ranking has not been boosted by the desired (or alternatively, preset) range or more as a ranking-boosting content.

Here, the desired (or alternatively, preset) range may be set in various ways, for example, a ranking-boosting range of “3 steps”. For example, when a specific content ranked fourth on a past occasion is ranked first on a specific occasion, it may be expressed that the specific content has been boosted three steps in ranking. In this case, because the specific content has been boosted in ranking by the desired (or alternatively, preset) range, the specific content is a content that satisfies the desired (or alternatively, preset) ranking condition may be selected as a ranking-boosting content.

Meanwhile, a popularity ranking on a specific occasion and a past occasion when the popularity of the contents is calculated may correspond to a popularity ranking on a specific day of the week when the content is serialized. Further, in this case, the specific occasion may be the present occasion, and the past occasion may be a previous occasion that is a unit period of time from the present occasion. the unit period of time may correspond to one week. For example, a specific occasion may be a day of the week corresponding to today (e.g., “Wednesday”), and a past occasion may be a day of the week corresponding to one week ago with respect to today (e.g., Wednesday one week before today).

The control unit 130 may compare the present ranking to a ranking of the previous week, and determine whether a ranking of contents satisfies the desired (or alternatively, preset) ranking condition. Such ranking changes in contents may be helpfully used, when displaying a collection of contents with reference to the day of the week.

As described above, the control unit 130 may compare the present ranking to the ranking of the previous week to determine whether the ranking of the content has been boosted by a desired (or alternatively, preset) range, and when the ranking has been boosted by the desired (or alternatively, preset) range, select the corresponding content as a ranking-boosting content. In this case, the control unit 130 may subtract the ranking of the present occasion from the ranking of the past occasion, and determine whether a subtracted value is equal to or greater than a specific value corresponding to the desired (or alternatively, preset) range (e.g., three steps). Further, when the subtracted value is equal to or greater than the specific value, the corresponding content may be selected as a ranking-boosting content.

For example, as illustrated in FIG. 5, a first content corresponding to “Mysterious World” may be selected as a ranking-boosting content in the reference of overall popularity ranking because the first content had 3 steps of ranking-boosting that satisfies the desired (or alternatively, preset) range compared to the previous week (changed 4th→1st). In contrast, since the first content corresponding to “Mysterious World” did not have any ranking-boosting that satisfies the desired (or alternatively, preset) range in the reference of popularity ranking for females (stayed the same at 4th→4th) and popularity ranking for males (dropped 4th→5th), the first content may not be selected as a ranking-boosting content in the reference of popularity ranking for females and popularity ranking for males.

For another example, because a second content corresponding to “Weekend” had 3 steps or more of ranking-boosting that satisfies the desired (or alternatively, preset) range in the references of overall popularity ranking (changed 10th→6th) and popularity ranking for females (changed 5th→2nd), the second content may be selected as a ranking-boosting content in the references of overall popularity ranking and popularity ranking for females. In contrast, because the second content has been only ranking-boosted by 2 steps in the reference of popularity ranking for males (changed 7th→5th) and does not satisfy the desired (or alternatively, preset) range, the second content may not be selected as a ranking-boosting content in the reference of popularity ranking for males.

In some example embodiments, the desired (or alternatively, preset) ranking condition may relate to whether a ranking of a content has been boosted over a plurality of occasions.

When a ranking of contents has been continuously boosted over a desired (or alternatively, preset) plurality of past occasions, the control unit 130 may determine the corresponding contents as ranking-boosting contents. The control unit 130 may select a content that has continuously been boosted in ranking over a desired (or alternatively, preset) plurality of past occasions as a ranking-boosting content. In some example embodiments, a range of the plurality of past occasions may be predetermined. For example, the control unit 130 may select a content whose ranking has been consecutively boosted in three or more past occasions, up to the present occasion, as a ranking-boosting content.

Meanwhile, the plurality of occasions may be past occasions that are off by at least one unit period of time with respect to the present occasion. For example, the plurality of past occasions may include i) a first past occasion (e.g., one week ago from the present) being prior to the specific occasion corresponding to the present occasion by the unit period of time (e.g., one week), ii) a second past occasion (e.g., two weeks ago from the present) being prior to the first past occasion by the unit period of time, and iii) a third past occasion (e.g., three weeks ago from the present) being prior to the second past occasion by the unit period of time. The control unit 130 may select a content whose ranking has been continuously boosted over the third past occasion, the second past occasion, the first past occasion, and the specific occasion as a ranking-boosting content.

That is, the control unit 130 may exclude a content whose ranking has not been boosted compared to an immediate previous occasion among the third past occasion, the second past occasion, the first past occasion, and the specific occasion (the present occasion) from being selected as a ranking-boosting content. For example, as illustrated in FIG. 5, because the “Four Seasons” content had the same ranking of 7th in the third past occasion (3 weeks ago with respect to the present) and the second past occasion (2 weeks ago with respect to the present) in the reference of “popularity ranking for females”, the content has not been boosted in ranking over the desired (or alternatively, preset) plurality of occasions of 3 consecutive weeks. In this case, the control unit 130 may not select the “Four Seasons” content as a ranking-boosting content.

Meanwhile, the control unit 130 may select a content whose ranking has been boosted by a desired (or alternatively, preset) range in the specific occasion compared to the first past occasion as a ranking-boosting content, even if the content is a content whose ranking has not been boosted compared to an immediate previous occasion among the third past occasion, the second past occasion, the first past occasion, and the specific occasion. That is, the control unit 130 may determine a content whose ranking has been boosted by a desired (or alternatively, preset) range compared to the immediate previous occasion (e.g., last week) as a ranking-boosting content, even if the content has not been boosted in ranking over a plurality of consecutive occasions.

For example, in case of the “Rain” content in FIG. 5, the ranking for the third past occasion (3 weeks ago) and the second past occasion (2 weeks ago) are the same as 7th, with reference to the popularity ranking for males, so that the ranking has not boosted over a plurality of occasions (3 consecutive weeks), but the ranking for the specific occasion compared to the first past occasion (i.e., compared to last week) has been boosted by the desired (or alternatively, preset) range or more (6th→1st), so the corresponding content may be selected as a ranking-boosting content.

Meanwhile, the control unit 130 may not select a content as a ranking-boosting content when the content has a history of a drop in ranking over a plurality of past occasions even if the content has been boosted in ranking above a desired (or alternatively, preset) range compared to an immediate previous occasion, that is, compared to last week. For example, in case of the “Rine” content in FIG. 5, with reference to the overall popularity ranking, even if the content has been boosted by 6 steps compared to an immediate previous occasion (compared to last week), the ranking between the third past occasion and the second past occasion, that is, the ranking between 3 weeks ago and 2 weeks ago, has been dropped (e.g., dropped by 4 steps). In this case, the control unit 130 may not select the corresponding content as a ranking-boosting content because the content has a history of a drop in ranking over a plurality of past occasions.

As described above, the control unit 130 may select a content whose present popularity ranking has been boosted by the desired (or alternatively, preset) range compared to last week, or a content whose ranking has been boosted consecutively over a plurality of past occasions, as a ranking-boosting content. In this case, the control unit 130 may not select the corresponding content as a ranking-boosting content when the content has a history of a drop in ranking on at least one of the plurality of past occasions, even if the present popularity ranking of the content has been boosted by the desired (or alternatively, preset) range compared to last week. Meanwhile, the control unit 130 may calculate a ranking of contents for the contents being serialized with reference to a day of the week, as described above. In this case, the present occasion may correspond to a day of the week that the corresponding content is being serialized. For example, a content that is serialized on Wednesday may be compared in ranking between present Wednesday corresponding to the present of the corresponding content and Wednesday of last week.

Hereinafter, a ranking calculation logic that selects the ranking-boosting content described above will be described in more detail.

As described above, the control unit 130 may use a variety of logic to select the ranking-boosting content.

A first logic may be a logic that determines whether the present ranking of a content has been boosted by a desired (or alternatively, preset) range compared to last week. For example, the first logic may be a logic that determines whether the popularity ranking of the content on a specific occasion has been boosted higher than the popularity ranking of the content on a past occasion before a desired (or alternatively, preset) unit period of time (e.g., one week).

As illustrated in FIG. 6A, the control unit 130 may extract a calculation value (e.g., a first calculation value) by subtracting the present occasion (present ranking) from the past occasion (last week ranking) (S610). Further, the control unit 130 may determine whether the calculation value is equal to or greater than a reference value corresponding to a value that is equal to or greater than a desired (or alternatively, preset) range (e.g., a first reference value (e.g., “3” (3 steps of ranking-boosting))) (S620). As a result of the determination, when the calculation value is equal to or greater than the reference value, the control unit 130 selects the corresponding content as a ranking-boosting content (S630), and when the calculation value is less than the reference value, the control unit 130 may not select the corresponding content as a ranking-boosting content (S640). For example, as illustrated in (a) of FIG. 6B, a specific content (“Mysterious World”) may be selected as a ranking-boosting content because the content had been boosted in ranking by 3 or more steps compared to last week. Further, as illustrated in (b) and (c) of FIG. 6B, the specific content (“Mysterious World”) may not be selected as a ranking-boosting content because the content did not have as much ranking-boosting as the desired (or alternatively, preset) range compared to last week.

Further, a second logic may be a logic that determines whether a ranking of a content has been boosted over a plurality of past occasions up to the present. As described above, the plurality of past occasions may include i) a first past occasion (e.g., one week ago from the present) being prior to the specific occasion corresponding to the present occasion by the unit period of time (e.g., one week), ii) a second past occasion (e.g., two weeks ago from the present) being prior to the first past occasion by the unit period of time, and iii) a third past occasion (e.g., three weeks ago from the present) being prior to the second past occasion by the unit period of time.

The second logic may be a logic that determines whether the content has had continuously been boosted in ranking over a plurality of past occasions (e.g., past occasions corresponding to up to three weeks ago). For example, the second logic may be a logic that determines whether the content has been boosted in ranking for three consecutive weeks.

As illustrated in FIG. 7A, the control unit 130 may determine whether the content has had ranking-boosting over a plurality of past occasions (e.g., three consecutive weeks) (S710). As a result of the determination, the control unit 130 may select the corresponding content as a ranking-boosting content when the content has been boosted in ranking for a plurality of past occasions (e.g., three consecutive weeks) (S720). Further, as a result of the determination, the control unit 130 may not select the corresponding content as a ranking-boosting content when the content has not been boosted in ranking for a plurality of past occasions (e.g., three consecutive weeks) (S730). For example, as illustrated in (a) of FIG. 7B, the specific content (“Four Seasons”) may be selected as a ranking-boosting content because the content had ranking-boosting for three consecutive weeks. Further, as illustrated in (b) and (c) of FIG. 7B, the specific content (“Four Seasons”) may not be selected as a ranking-boosting content because the content has not been boosted in ranking for three consecutive weeks.

Next, a third logic may be a logic that excludes a content that has satisfied a desired (or alternatively, preset) unsatisfied condition from the contents selected as the ranking-boosting content. The third logic may be determined for the content that is selected as the ranking-boosting content by satisfying the first logic. That is, the control unit 130 may select the ranking-boosting contents according to the first logic, and then, exclude some of the ranking-boosting contents from the ranking-boosting contents according to the third logic. The third logic may be logic that determines whether there is a history of a drop in ranking on at least some of the plurality of past occasions up to the present. As described above, the plurality of past occasions may include i) a first past occasion (e.g., one week ago from the present) corresponding to a unit period of time (e.g., one week) prior to the specific occasion corresponding to the present occasion, ii) a second past occasion (e.g., two weeks ago from the present) corresponding to the unit period of time prior to the first past occasion, and iii) a third past occasion (e.g., three weeks ago from the present) corresponding to the unit period of time prior to the second past occasion. The control unit 130 may exclude the corresponding content from the ranking-boosting content when there is an occasion in which the ranking has dropped among a plurality of past occasions, for example, when there is a history of a drop in ranking within three weeks according to the second logic among the contents selected as the ranking-boosting content according to the first logic.

As described above, the control unit 130 may select the ranking-boosting content, according to the first logic or the second logic, and exclude at least some of the ranking-boosting contents according to the third logic from the ranking-boosting contents selected according to the first logic.

As illustrated in FIG. 8A, the control unit 130 may determine (S810) whether there is a ranking drop within a plurality of past occasions (e.g., within three weeks) for the contents that satisfy the first logic. As a result of the determination, the control unit 130 may exclude the corresponding content from the ranking-boosting content when the ranking of the corresponding content has a history of a drop in ranking on some of the plurality of past occasions (S820). Further, as a result of the determination, the control unit 130 may maintain the corresponding content as the ranking-boosting content when the ranking of the corresponding content does not have a history of a drop in ranking on some of the plurality of past occasions (S830). For example, as illustrated in (a) of FIG. 8B, because a specific content (“Rain”) is a content that has been boosted in ranking by a desired (or alternatively, preset) range or more (6 steps of ranking-boosting) compared to last week that satisfies the first logic, but has experienced a drop in ranking between 2 weeks ago and 1 week ago, the specific content may be excluded from the ranking-boosting content.

In addition, for example, as illustrated in (b) of FIG. 8B, because the specific content (“Rain”) is a content that has been boosted in ranking by the desired (or alternatively, preset) range or more (5 steps of ranking-boosting) compared to last week that satisfies the first logic, and also is a content that satisfies the third logic (e.g., there is no history of a drop in ranking within 3 weeks), the specific content may be maintained as the ranking-boosting content.

Meanwhile, the control unit 130 may not output the ranking-boosting information in case of a newly serialized content for which no past data (that is, a ranking from last week) exists compared to the present occasion.

As described above, in the method of providing contents according to some example embodiments of the present inventive concepts, a popularity ranking of each of contents may be calculated on the basis of various references, and ranking-boosting information may be provided for ranking-boosting contents that satisfy a desired (or alternatively, preset) ranking condition, thereby effectively providing a user with information on contents that are rapidly increasing in popularity or are continuously popular. In other words, the control unit (e.g., processing circuitry) calculates a popularity ranking of each of the contents serialized to a day of a week based on one or more references and stores the calculated popularity ranking in association with an occasion (e.g., a point in time) in a database (see FIG. 5), in the background. Accordingly, individual users can recognize one or more popular contents at a glance without performing separate resources (e.g., computing and communication resources) and power consuming operations.

Further, the control unit 130 calculates a popularity ranking for the contents by various references (e.g., a popularity ranking for females and a popularity ranking for males) and provides the popularity ranking to the user by sorting the popularity ranking on different pages, respectively, thereby enabling the user to identify information on popular contents by various references at a glance.

Meanwhile, on the page on which the items of the contents are disposed, when a specific item is selected from the user terminal, for example, when an item corresponding to the ranking-boosting content is selected by the user terminal, the control unit 130 may provide the user terminal with an episode page of the content corresponding to the selected item. In this case, the user terminal may be provided with the episode page, which includes an episode list of the content corresponding to the selected item. For example, when an item of the ranking-boosting content is selected, the user terminal may be provided with an episode page that includes an episode list of the episodes constituting the selected ranking-boosting content.

As described above, methods and systems for providing contents according to some example embodiments of the present inventive concepts provide an intuitive user environment that enables users to identify at a glance information on contents that are serialized on each day of the week by collecting and providing information on contents that are serialized on the basis of a day of the week on a specific service page.

Further, the method and system for providing contents according to some example embodiments of the present inventive concepts can calculate a popularity ranking of serialized contents on every specific day of the week, and use the calculated popularity ranking to provide a user with information on popular contents.

Further, the example embodiments of the present inventive concepts described above may be implemented as computer-readable code or instructions on a medium in which a program is recorded. That is, some example embodiments of the present inventive concepts may be provided in the form of a non-transitory computer readable medium storing a program.

Meanwhile, the computer-readable medium includes all kinds of storage devices for storing data readable by a computer system. Some examples of computer-readable media include hard disk drives (HDDs), solid state disks (SSDs), silicon disk drives (SDDs), ROMs, RAMs, CD-ROMs, magnetic tapes, floppy discs, and optical data storage devices.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Further, the computer-readable medium may be a server or cloud storage that includes storage and that the user terminal is accessible through communication. In this case, the computer may download a program according to an example embodiment of the present inventive concepts from the server or cloud storage, through wired or wireless communication.

Further, in some example embodiments of the present inventive concepts, the computer described above may be a user terminal equipped with a processor, that is, a central processing unit (CPU), and is not particularly limited to any type.

Meanwhile, it should be appreciated that the detailed description is interpreted as being illustrative in every sense, not restrictive. The scope of the present inventive concepts should be determined based on the reasonable interpretation of the appended claims, and all of the modifications within the equivalent scope of the present inventive concepts belong to the scope of the appended claims.

What is claimed is:

1. A method of providing contents comprising:
specifying contents to be serialized on a specific day of a week, among a plurality of contents each serialized with reference to a day of the week;
calculating a popularity ranking for each of the specified contents;
selecting, using the popularity ranking, a ranking-boosting content satisfying a ranking condition among the specified contents; and
providing, on a user terminal, items corresponding to each of the specified contents,
wherein the providing includes displaying ranking-boosting information related to ranking-boosting on an item corresponding to the ranking-boosting content, among the items corresponding to each of the specified contents.

2. The method of claim 1, wherein the ranking condition is related to whether the popularity ranking of each of the specified contents on a plurality of different occasions has been boosted.

3. The method of claim 2, wherein the ranking condition is related to whether the popularity ranking of each of the specified contents has been boosted by a range or more at a specific occasion compared to a past occasion, the past occasion being at least one unit period of time prior to the specific occasion.

4. The method of claim 3, wherein the selecting of the ranking-boosting content selects a specific content as the ranking-boosting when the popularity ranking of the specific content from among the specified contents has been boosted by the range at the specific occasion compared to the past occasion.

5. The method of claim 4, wherein
the popularity ranking at the specific occasion and the past occasion of each of the specified contents corresponds to the popularity ranking at the specific day of the week on which each of the specified contents is serialized,
the specific occasion corresponds to a present occasion on which the specified contents are serialized,
the unit period of time corresponds to one week, and
the past occasion includes a first past occasion corresponding to one week prior to the specific occasion.

6. The method of claim 5, wherein the ranking-boosting content is a content, from among the specified contents, whose present popularity ranking on the specific day of the week has been boosted by the range or more compared to last week.

7. The method of claim 3, wherein in the selecting of the ranking-boosting content selects, among the specified contents, a content whose present popularity ranking on the specific day of the week has been boosted by the range or more compared to last week or a content whose popularity ranking has been boosted continuously over a plurality of past occasions,, as the ranking-boosting content.

8. The method of claim 2, wherein the selecting of the ranking-boosting content selects, among the specified contents, a content whose ranking has continuously been boosted over a plurality of past occasions, as the ranking-boosting content.

9. The method of claim 8, wherein
the plurality of past occasions includes a first past occasion being prior to a specific occasion by a unit period of time, a second past occasion being prior to the first past occasion by the unit period of time, and a third past occasion being prior to the second past occasion by the unit period of time, and
the ranking-boosting content is a content whose popularity ranking has continuously been boosted over the third past occasion, the second past occasion, the first past occasion, and the specific occasion.

10. The method of claim 9, wherein the selecting of the ranking-boosting content comprises excluding, among the specified contents, a content whose popularity ranking has not been boosted compared to an immediate previous occasion among the third past occasion, the second past occasion, the first past occasion, and the specific occasion, from the ranking-boosting content.

11. The method of claim 10, wherein the selecting of the ranking-boosting content selects, among the specified contents, a content whose present popularity ranking has been boosted by a range or more compared to the first past occasion as the ranking-boosting content, even if whether the popularity ranking of the content has not been boosted compared to an immediate past occasion among the third past occasion, the second past occasion, the first past occasion, and the specific occasion.

12. The method of claim 1, further comprising:
providing a plurality of service pages each matched to a different day of the week,
wherein the providing of the items provides the items corresponding to each of the specified contents on a corresponding service page matched to the specific day of the week among the plurality of service pages.

13. The method of claim 12, further comprising:
sequentially disposing the items corresponding to each of the specified contents on the specific service page according to the popularity ranking for each of the specified contents that is calculated based on one of a plurality of sorting references.

14. The method of claim 1, wherein
the items corresponding to the ranking-boosting content includes a thumbnail image corresponding to the ranking-boosting content and a graphic object corresponding to the ranking-boosting information, and
the graphic object overlaps on the thumbnail image.

15. The method of claim 14, wherein the graphic object corresponding to the ranking-boosting information includes guidance information indicating a reason the ranking-boosting content has been selected as the ranking-boosting content.

16. The method of claim 14, wherein, when the items corresponding to the ranking-boosting content is selected by the user terminal, the user terminal is provided with an episode page that includes an episode list of episodes constituting the ranking-boosting content.

17. A system for providing contents comprising:
a database configured to store a plurality of contents; and
processing circuitry configured to
specify contents to be serialized on a specific day of a week among the plurality of contents,
calculate a popularity ranking for each of the specified contents to be serialized on the specific day of the week,
select, using the popularity ranking, a ranking-boosting content that satisfies a ranking condition among the specified contents, and
provide, on a user terminal, items each corresponding to the specified contents,
wherein the processing circuitry is configured to provide the items by displaying ranking-boosting information related to ranking-boosting on an item corresponding to the ranking-boosting content, among the items corresponding to each of the specified contents.

18. A non-transitory computer readable medium storing a program that when executed by one or more processors on an electronic device, causes the electronic device to perform a method of providing contents, the method comprising:
specifying contents to be serialized on a specific day of a week among a plurality of contents each serialized with reference to a day of the week;
calculating a popularity ranking for each of the specified contents;
selecting, using the popularity ranking, a ranking-boosting content satisfying a ranking condition among the specified contents; and
providing, on a user terminal, items corresponding to each of the specified contents,
wherein the providing includes displaying ranking-boosting information related to ranking-boosting on an item corresponding to the ranking-boosting content, among the items corresponding to each of the specified contents.
